(19) United States
(12) Patent Application Publication
(10) Pub. No.: US 2022/0266617 A1
(43) Pub. Date: Aug. 25, 2022

(54) Method for Marking Workpieces and Workpiece

(71) Applicant: Fraunhofer-Gesellschaft zur Förderung der angewandten Forschung e.V., Muenchen (DE)

(72) Inventors: Thomas Härtling, Dresden (DE); Christoph Zeh, Dresden (DE); Björn Erik Mai, Dresden (DE); Manuela Heymann, Dresden (DE)

(21) Appl. No.: 17/627,031

(22) PCT Filed: Aug. 4, 2020
(86) PCT No.: PCT/EP2020/071888

§ 371 Date: Jan. 13, 2022

(30) Foreign Application Priority Data
Aug. 8, 2019 (DE) 10 2019 121 447.5

(51) Int. Cl. B41M 5/00; B41M 7/00; C21D 7/06; C23F 1/02; B21D 22/02; B24C 1/08

(52) U.S. Cl. CPC B41M 5/0058; B41M 5/0047; B41M 7/009; C21D 7/06; B41M 5/0023; C23F 1/02; B21D 22/022; B24C 1/08

(57) ABSTRACT

In an embodiment a method includes providing a workpiece, attaching a marking to the workpiece such that the marking is integrally bonded to the workpiece, wherein attaching the marking includes applying at least one raw material for the marking, heating the workpiece with the at least one raw material such that the marking is formed from the at least one raw material and performing a surface treatment of the workpiece at least in an area with the marking, wherein performing the surface treatment includes shot peening, sand blasting or material-removing etching against which the marking is resistant to, wherein the marking remains readable on the workpiece at least until after performing the surface treatment, and wherein the marking has, in at least a part of a near ultraviolet, a visible and/or a near-infrared spectral range relative to the workpiece, at least one of a degree of reflection difference, a reflectance difference or an albedo difference of at least 10 percentage points.

This patent application is a national phase filing under section 371 of PCT/EP2020/071888, filed Aug. 4, 2020, which claims the priority of German patent application 102019121447.5, filed Aug. 8, 2019, each of which is incorporated herein by reference in its entirety.

### TECHNICAL FIELD

A method for marking workpieces is specified. In addition, a workpiece with a marking is specified.

### BACKGROUND

International Patent Application Publication No. WO 2011/101001 A1 describes a method in which metallic components are provided with a fluorescent marking.

US Patent Application Publication No. 2016/0339495 A1 relates to a method in which workpieces with a marking are hot-formed.

### SUMMARY OF THE INVENTION

Embodiments provide a workpiece with a marking that survives a surface treatment in a readable manner.

According to at least one embodiment, the method includes the step of providing a workpiece. The workpiece is, for example, a metallic material, in particular a metal sheet. The workpiece can be an iron sheet or a steel sheet or else an aluminum sheet. A thickness of the workpiece is, for example, at least 0.1 mm or 0.3 mm or 0.5 mm and/or at most 8 mm or 5 mm or 3 mm.

According to at least one embodiment, the method comprises the step of attaching the marking to the workpiece, so that the marking is bonded to the workpiece in a positive substance joining manner. The attachment is, for example, pressing components of the marking into the workpiece surface.

According to at least one embodiment, the method comprises the step of applying one or more raw materials for one or more markings to the workpiece. The at least one raw material, and thus the at least one marking, is preferably applied to the workpiece only in places and not over the entire surface. The at least one raw material, and thus the at least one marking, is applied, for example, in the form of a lettering or a number. The at least one raw material, and thus the at least one marking, is preferably a machine-readable coding, in particular in the form of a bar code or a two-dimensional code. Via the finished marking, it is possible, for example, to give the workpiece a unique component number.

According to at least one embodiment, the method comprises the step of heating the workpiece with the at least one raw material. As a result of the heating, the marking is formed from the raw material. In this case, the marking is connected to the workpiece in a materially bonded manner. This takes place, for example, in that a part of the raw material reacts chemically with the workpiece or fuses to the workpiece. As a result, the marking adheres firmly to the workpiece.

According to at least one embodiment, the method comprises the step of performing a surface treatment of the workpiece. The surface treatment is carried out at least in one region with the marking. The surface treatment can extend on an entire main side of the workpiece or also on two main sides of the workpiece.

According to at least one embodiment, the surface treatment is a shot peening, a sand blasting, a sliding grinding, and alternatively or additionally a material-removing treatment. Examples of a material-removing treatment are etching or removal by means of electromagnetic radiation.

According to at least one embodiment, the marking remains readable at least until after the surface treatment, preferably machine-readable, on the workpiece. In particular, the marking can be read, specifically machine-read, both after the heating step and immediately before the surface treatment and after the surface treatment. This means that the marking is not destroyed by the surface treatment.

According to at least one embodiment, the marking has, at least in a part of the near ultraviolet, the visible and/or the near-infrared spectral range with respect to the workpiece after the surface treatment, preferably also with respect to the workpiece before the surface treatment, a degree of reflection difference and/or a degree of reflectance difference and/or an albedo difference, in particular under optimized lighting conditions and detection conditions, of at least 10 percentage points or 20 percentage points or 30 percentage points.

In other words, due to its optical properties, the marking can be clearly distinguished both from a surface of the workpiece and preferably also before the surface treatment, for example, by a camera or by the human eye. In other words, the marking on a surface of the workpiece has a high contrast, at least under suitable illumination conditions which are used for reading out the marking.

The near ultraviolet spectral range is understood to mean, in particular, the range from 300 nm to 420 nm, the visible spectral range denotes in particular wavelengths from 420 nm to 760 nm and the near-infrared spectral range wavelengths from 760 nm to 1500 nm. It is possible that optical filters are used for reading out the marking, which filters, for example, block an excitation wavelength of a phosphor, so that only the radiation generated by the phosphor of the marking due to the excitation is detected. Preferably, the marking with respect to the contrast and/or a difference in brightness satisfies the standard ISO IEC TR 29158 (2011) (previously standard AIN DPM-1-2006), which is required for directly marked components.

In at least one embodiment, the method comprises the following steps, preferably in the stated sequence:
A) providing the workpiece,
B) attaching the marking to the workpiece, so that the marking is integrally bonded to the workpiece, and
D) carrying out a surface treatment of the workpiece at least in an area with the marking, wherein the surface treatment in step D) is a shot peening, a sand blasting, a sliding grinding and/or a material-removing treatment,
the marking remains readable on the workpiece at least until after step D), and
in at least one part of the near ultraviolet, the visible and/or the near-infrared spectral range, the marking has a difference in reflectance and/or a difference in reflectance and/or an absolute difference of at least 10 percentage points with respect to the workpiece.

This method enables an individual identification of metal components which are subjected to the process of shot peening, sand blasting, sliding grinding or another surface process, such as chemical etching. The identification is preferably applied before the process and is still readable, in particular machine-readable, after the process.

The shot peening is used, for example, to adjust the surface hardness or to clean metal components. Typical conventional identifications, above all laser engraving and printing with conventional, in particular organic inks, frequently fail in this context. The reason for this is the change or even the removal of the surface, which leads to washing of the contrast, for example, of a laser marking, or to removal of an ink. This is particularly critical when a high-temperature process, such as press hardening, is directly connected upstream of the shot peening. In the case of a conventional marking, such a high-temperature process can already impair its adhesion to the workpiece or the contrast thereof to the workpiece.

Similarly, sand blasting is used to remove scale from, for example, stainless steel sheets which have previously passed through a high temperature process.

In the method described here, on the other hand, a raw material for a marking, for example, a data matrix code, DMC for short, is applied to the workpiece, for example, printed. The ink used here preferably contains ceramic pigments which are bonded to a workpiece surface, which is in particular a metal surface, in a materially bonded manner and thus highly resistant. This connection is carried out in a temperature step, for example, the temperature treatment, which occurs anyway in a processing process of the workpiece. Alternatively, an additional temperature step, for example, by inductive heating or by a direct flame, can be used.

Furthermore, with the method described here, it is possible that pigments of the marking are pressed into the workpiece surface by the shot peening, whereby a temperature step can be dispensed with. Alternatively or additionally, the step of heating and the shot peening and/or sand blasting and/or sliding grinding follow one another.

The marked workpieces can thus be individually identified. This enables component tracking and monitoring of a component current over the production process. Process optimizations can be carried out on the basis of this monitoring. This applies in particular in metal processing, for example, in the production of automotive components, such as car body components.

According to at least one embodiment, the marking comprises at least one temperature-resistant, coloring material or consists of one or more such materials. Such a material is formed in particular by pigments, for example, from temperature-resistant ceramic pigments and/or metal oxide pigments with a color different from the workpiece. For example, the ceramic pigments are white, colored or black. A plurality of subregions of the marking can be present which have different colors in order to ensure an increased contrast within the marking.

According to at least one embodiment, the marking includes one or more kinds of metal oxide pigments. For example, the pigments of the marking are composed of titanium dioxide.

According to at least one embodiment, the marking contains one or more phosphors. The at least one phosphor effects a difference in reflectance between the marking and the blank and the workpiece. Phosphors can have a reflectance of more than 100% in spectral subregions in which the phosphor emits via photoluminescence. A degree of reflection exceeding 100% is caused by the secondary light generated by the phosphor.

The phosphor or the phosphor mixture preferably contains at least one of the following phosphors or consists thereof: Eu²⁺-doped nitrides like (Ca,Sr)AlSiN₃:Eu²⁺, Sr(Ca,Sr)Si₂Al₂N₆:Eu²⁺, (Sr,Ca)AlSiN₃*Si₂N₂O:Eu²⁺, (Ca,Ba,Sr)₂Si₅N₈:Eu²⁺, (Sr,Ca)[LiAl₃N₄]:Eu²⁺; garnets from the general system (Gd,Lu,Tb,Y)₃(Al,Ga,D)₅(O,X)₁₂:RE with X=halide, N or divalent element, D=three- or four-valent element and RE=rare earth metal like Lu₃(Alₗ₋ₓGaₓ)₅Oₗ₂:Ce³⁺, Y₃O₁₋ₓGaₓ)₅O₁₂:Ce³⁺; Eu²⁺-doped sulfides like (Ca,Sr,Ba)S:Eu²⁺; Eu²⁺-doped SiONs like (Ba,Sr,Ca)Si₂O₂N₂:Eu²⁺; SiAlONs, for example, from the system LiₓM_{y}Ln_{z}Si₁₂₋₍ₘ₊ₙ₎Al₍ₘ₊ₙ₎OₙN₁₆₋ₙ; beta-SiAlONs from the system Si₆₋ₓAl_{z}O_{y}N_{8-y}:RE_{z}; nitrido-orthosilikates like AE₂₋ₓ₋ₐREₓEuₐSiO₄₋ₓNₓ, AE₂₋ₓ₋ₐREₓEuₐSi_{1-y}O_{4-x-2y}Nₓ with RE=rare earth metal and AE=alkaline earth metal; orthosilikates like (Ba,Sr,Ca,Mg)₂SiO₄:Eu²⁺; chlorosilikates like Ca₈Mg(SiO₄)₄Cl₂:Eu²⁺; chlorophosphates like (Sr,Ba,Ca,Mg)₁₀(PO₄)₆Cl₂:Eu²⁺; BAM phosphors from the BaO—MgO—Al₂O₃ system like BaMgAl₁₀O₁₇:Eu²⁺; halophosphates like M₅(PO₄)₃(Cl,F):(Eu²⁺,Sb³⁺, Mn²⁺); SCAP phosphors like (Sr,Ba,Ca)₅(PO₄)₃Cl:Eu²⁺; KSF phosphors based on potassium, silicon and fluorine such as K₂SiF₆:Mn⁴⁺. Furthermore, the phosphor can have a quantum well structure and can be grown epitaxially.

The phosphor can be configured to shorten the wavelength of an excitation radiation, also referred to as upconversion, and, for example, to convert infrared light into visible light. Alternatively, the phosphor can convert short-wave light into long-wave light. Excitation of the phosphor takes place in the near ultraviolet, in the visible and/or near-infrared spectral range. The phosphor is preferably read out in the visible or near ultraviolet spectral range.

According to at least one embodiment, the coloring material, that is, the ceramic or metal oxide pigments or the phosphor, is present as particles. An average diameter of the particles, in particular a D50 diameter, is preferably at least 50 nm or 500 nm and/or at most 20 μm or 5 μm. Particles having an average diameter of 50 nm to 500 nm are used in particular in order to keep mechanical damage to the particles low during the surface treatment, especially during shot peening. In order to obtain a high thermal resistance of the particles, the average diameter is preferably between 0.5 μm and 5 μm inclusive.

According to at least one embodiment, the particles are only partially pressed into the workpiece during the surface treatment. A penetration depth of the particles into the workpiece is in particular at least 20% and less than 100%. This applies, for example, to at least 50% or 80% of the particles.

According to at least one embodiment, the surface treatment comprises etching as the material-removing treatment or the surface treatment is etching. The etching is in particular a wet chemical etching. Preferably, the marking is resistant to the etching. This means that removal of material from the workpiece preferably remains limited to regions adjacent to the marking. In other words, the marking can serve as a type of etching mask. This does not rule out that the marking can be undercut by the etching, so that a material of the workpiece is partially removed from a region covered by the marking.

According to at least one embodiment, the raw material is applied directly to a base material of the workpiece. The base material is, for example, a metal such as a copper sheet, an aluminum sheet, an iron sheet or a steel sheet. The marking is thus preferably produced directly on the base material.

According to at least one embodiment, the workpiece comprises a coating. The raw material is applied to the coating. In this case, the coating covers the base material of the workpiece in places or completely. This means that the marking is produced directly on the coating. Optionally, the marking remains spaced from the base material. Alternatively, the marking is pressed through the coating and contacts the base material in places.

According to at least one embodiment, when the marking and/or the raw material is heated in regions next to the marking, an additional layer, for example, a scaling layer, is produced. This applies in particular to iron-containing workpieces. Preferably, the additional layer, that is, specifically the scaling layer, is partially or completely removed during the surface treatment.

According to at least one embodiment, the step of heating the raw material comprises hot forming the workpiece or is a hot forming of the workpiece. This means that the marking is then formed from the raw material during the hot forming.

According to at least one embodiment, the hot forming takes place at a deformation temperature. For example, the deformation temperature is at least 350° C. or 550° C. or 700° C. or 800° C. or 880° C. Alternatively or additionally, the deformation temperature is at most 1100° C. or 1000° C. or 950° C. In particular, the deformation temperature is about 930° C. The hot forming is then, for example, deep drawing or pressing.

At the deformation temperature, the phosphor and/or the ceramic of the marking are preferably thermally stable. It is possible for the phosphor to be changed in its luminescence properties, in particular by the temperatures during the hot forming. As a result, it is also possible to obtain a quality control as to whether the hot forming takes place with correct process parameters.

According to at least one embodiment, the raw material is attached to the workpiece in a wiping-proof manner after the step of applying, but still before the step of heating. That is to say, the marking does not adhere very firmly to the workpiece immediately after application, but at least so strongly that running of the marking or removal of the marking remains under a slight contact.

According to at least one embodiment, the marking remains permanently on the workpiece. In other words, the marking adheres to the workpiece in such a way that, in the intended use of the finished workpiece, no detachment or significant detachment of the marking from the workpiece takes place.

According to at least one embodiment, the raw material and/or the marking comprises a matrix material. The matrix material is, for example, a translucent, inorganic material, in particular a glass based on silicon dioxide. The matrix material acts as an adhesion promoter and as an adhesive between the workpiece and a coloring material of the marking. This means that the at least one phosphor or the ceramic pigments adhere to the workpiece due to the matrix material, that is to say on the basis of the adhesion promoter.

According to at least one embodiment, the raw material has an intermediate matrix. The intermediate matrix comprises in particular a binder and/or a solvent and/or a dispersant and/or a plasticizer. The intermediate matrix can be made of organic materials, for example, based on acrylate. The raw material, in particular the coloring component of the marking, such as the phosphor, is temporarily fastened to the workpiece via this intermediate matrix. In the finished marking, the intermediate matrix is preferably no longer present or only decomposition residues of the intermediate matrix are present.

According to at least one embodiment, the raw material comprises the inorganic adhesion promoter and the inorganic pigment particles or consists thereof. The adhesion promoter is a glass, a ceramic or a glass ceramic. The pigment particles are the phosphor and/or the ceramic pigments.

In particular, a phosphorus paste composition is used for the raw material, as described in document DE 602 18 966 T2. The disclosure content of this document with regard to the phosphorus paste composition is incorporated by reference.

According to at least one embodiment, the marking remains partially or completely embossed over the workpiece. This means that the marking is not pressed into the workpiece surface in particular during the surface treatment. As a result, a hardness of the workpiece at the workpiece surface can be increased by means of the shot peening. This effect can otherwise be reduced by significantly pressing the marking into the workpiece.

According to at least one embodiment, the marking comprises a plurality of point-like islands as seen in plan view. The islands are separated from one another and are not connected to one another by a material of the marking. An average diameter of the islands is, for example, at least 0.5 μm or 1 μm and/or at most 50 μm or 20 μm or 10 μm. In this case, at least one marking field of the marking, viewed in plan view, is preferably composed of the individual islands which can be present in a density modulation. An overall mean extent of the at least one marking field is preferably at least 20 times or 50 times the average diameter of the islands.

According to at least one embodiment, a coherent marking field is present. A continuous material connection of a material of the marking is preferably present within the marking field. The marking field can be a closed region which is continuous and uninterrupted in plan view.

According to at least one embodiment, the average roughness of the workpiece surface deviates from an average roughness of the marking by at least a factor of 2 or 5 or 10. As a result, the optical properties, in particular with regard to scattering, of the marking and of the workpiece can differ greatly, which can increase the contrast for reading out the marking.

According to at least one embodiment, in a further step, after the surface treatment, one or more lacquers are applied to the workpiece. The at least one lacquer preferably completely covers the marking. It is possible for the marking to be no longer recognizable through the lacquer for an observer or for a reading device. In this way, it can be that the marking is only visible and readable by removing the lacquer. A structure or form of the marking is preferably not or not significantly impaired by the lacquer.

In addition, a workpiece is specified. The workpiece is particularly preferably produced by a method as indicated in connection with one or more of the above-mentioned embodiments. Features of the method are therefore also disclosed for the workpiece and vice versa.

In at least one embodiment, the workpiece comprises a marking which is attached in places to a workpiece surface of the workpiece. The marking rests in a materially bonded manner on the workpiece surface. The workpiece surface was subjected to a shot peening, so that the workpiece surface shows a plurality of impressions of balls of the shot peening. The impressions extend over the marking.

### BRIEF DESCRIPTION OF THE DRAWINGS

A method described here and a workpiece described here are explained in more detail below with reference to the drawing on the basis of exemplary embodiments. Identical reference signs indicate identical elements in the individual figures. However, no true-to-scale references are shown; rather, individual elements may be exaggerated for a better understanding.

FIGS. 1 to 5 show schematic sectional illustrations of steps of an exemplary embodiment of a method described here for producing workpieces described here;

FIGS. 6 and 7 show schematic sectional illustrations of steps of an exemplary embodiment of a method described here for producing workpieces described here;

FIGS. 8 to 10 show schematic sectional illustrations of steps of an exemplary embodiment of a method described here for producing workpieces described here;

FIGS. 11 and 12 show schematic sectional illustrations of steps of an exemplary embodiment of a method described here for producing workpieces described here;

FIGS. 13 to 15 show schematic sectional illustrations of steps of an exemplary embodiment of a method described here for producing workpieces described here;

FIG. 16 shows schematic sectional illustrations of individual steps of an exemplary embodiment of a method described here for producing workpieces described here;

FIGS. 17 and 18 show schematic sectional illustrations of exemplary embodiments of workpieces described here; and

FIGS. 19 and 20 show schematic plan views of exemplary embodiments of workpieces described here.

### DETAILED DESCRIPTION OF ILLUSTRATIVE EMBODIMENTS

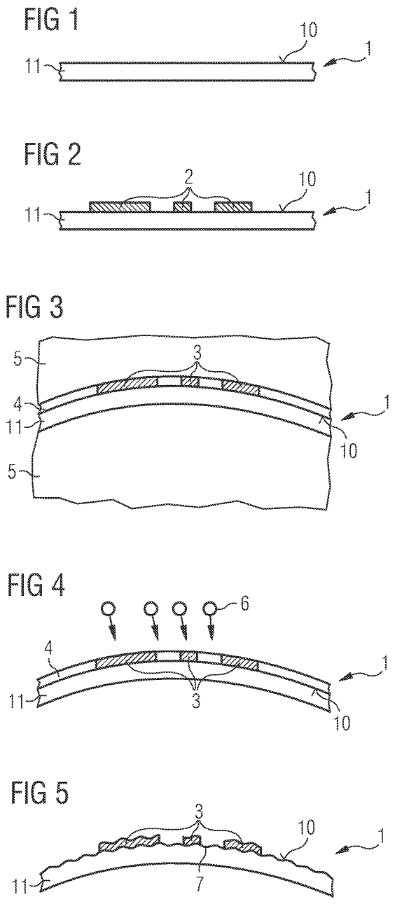

An exemplary embodiment of a method for marking a workpiece 1 is illustrated in FIGS. 1 to 5. According to FIG. 1, the workpiece 1 is provided which still has no marking. The workpiece 1 is preferably a steel sheet.

In the step of FIG. 2, a raw material 2 for the later marking is applied in places onto a workpiece surface 10. The application of the raw material 2 is, for example, printing. The raw material 2 is preferably an ink or a paste. The raw material 2 is applied in the shape how the finished marking is to be designed later, seen in plan view. After application, the raw material 2 is preferably wiping-resistant.

FIG. 3 shows that a hot forming of the workpiece 1 with the raw material 2 takes place, for example, in a heated press mold 5. With the hot forming, the raw material 2 is simultaneously heated so that the marking 3 is formed. In this case, a component of the raw material 2 preferably melts and is fixedly connected to the workpiece surface 10. Alternatively, a component of the raw material 2 reacts on the workpiece surface 10 with a material of the workpiece 1. As a result, the marking 3 is permanently and materially bonded to the workpiece 1.

As shown in FIG. 3, a scaling layer 4 is optionally formed on the workpiece surface 10. The scaling layer 4 is preferably restricted to regions next to the marking 3. In particular, the marking 3 is made of a material that is not oxidized or not significantly oxidized or reduced during hot forming.

In the step of FIG. 4, balls 6, for example, of stainless steel, were shot onto the workpiece surface 10, for example, by means of air pressure or by means of a drum in which the workpiece 1 is located. The balls 6 impact equally on the marking 3 and on regions next to the marking 3. As also in all other exemplary embodiments, a sand blasting can be used instead of or in addition to a shot peening.

The shot peening and/or the sand blasting is preferably carried out in accordance with DIN 8200. Preferably, blasting agents 6 with the following properties are used:
material group for the blasting agent 6: metallic, mineral, synthetic-organic,
density of the blasting medium 6: preferably between 1 g/cm³ and 9 g/cm³ inclusive,
hardness of the blasting medium 6 in the case of a metal: HV 30 to 1000, or hardness of the blasting medium 6 in the case of a mineral: MOHS≥3.

If, as an alternative or in addition to the shot peening and/or for sand blasting, a sliding grinding is used as surface treatment, the sliding grinding is preferably carried out in accordance with DIN 8589. A size of abrasive bodies is preferably between 0.5 mm and 50 mm. A sliding grinding is used, for example, for post-treatment of press-hardened metal sheets.

FIG. 5 shows the workpiece 1 after the shot peening. As a result of the shot peening, many impressions 7 of the balls 6 result in the workpiece surface 10, that is to say the workpiece surface 10 has a characteristic, pinned structure. This dented structure extends over the marking 3.

This structure with the impressions 7 is preferably also present below the marking 3 in the workpiece surface 10. The marking 3 preferably forms this structure. This means that the structure of the workpiece surface 10 is preferably recognizable on a marking side facing away from the workpiece surface 10.

Deviating from the illustration in FIG. 5, the scaling layer 4 can also be present at least partially on the workpiece 1 after the surface treatment.

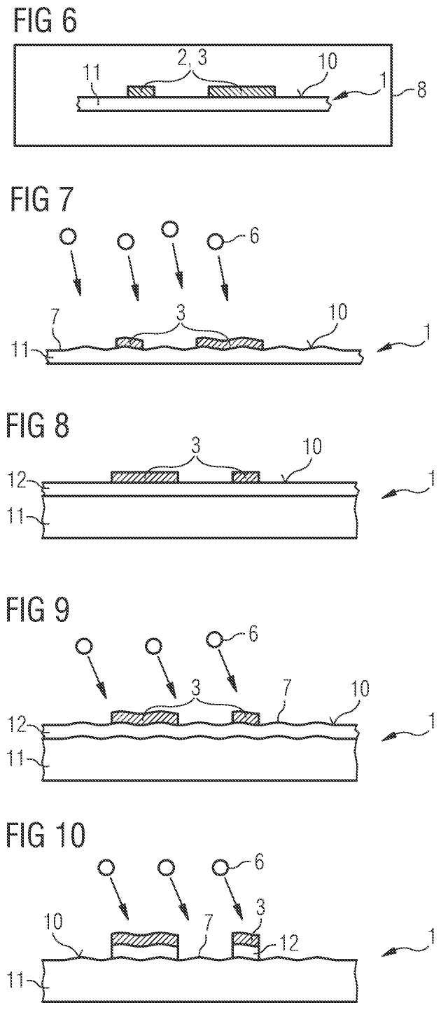

A further method is shown schematically in FIGS. 6 and 7. According to FIG. 6, the workpiece 1 with the raw material 2 is placed in a furnace 8. The furnace 8 is, for example, an induction furnace or a flame furnace. As a result of heating in the furnace 8, the marking 3 is created from the raw material 2.

Deviating from the illustration in FIG. 6, the workpiece 2 can have already been deformed before the application of the raw material 2, and thus before the introduction into the furnace 8. This deformation can thus be carried out before or even only after the raw material 2 has been applied. Alternatively, only the workpiece 1 with the finished marking 3 is deformed after the process step in the furnace. This optional downstream deformation is not shown in FIG. 6.

In the subsequent step, see FIG. 7, a shot peening again takes place. In this case, the workpiece surface 10 is hardened, for example. In addition, it is possible for a slight removal of material from the workpiece surface 10 due to the shot peening, wherein the marking 3 is preferably not significantly impaired by the shot peening.

Otherwise, the explanations regarding FIG. 4 apply to FIG. 7, and vice versa.

A further method is illustrated in connection with FIGS. 8 to 10. As shown in FIG. 8, the workpiece 1 is composed of a base material 11, for example, a steel sheet, and a coating 12. Preferably, the entire workpiece surface 10 is formed by the coating 12. Such a construction of the workpiece 1 can also be present in all other exemplary embodiments.

The marking 3 is applied to the coating 12, for example, as described in connection with FIG. 2, 3 or 6.

According to FIGS. 9 and 10, the shot peening is carried out, preferably analogously to FIGS. 4 and/or 7. In the variant of FIG. 9, the impressions 7 are formed in the coating 12, with the impressions 7 preferably continuing as far as the base material 11. Alternatively, the impressions 7 are damped by the coating 12 and are no longer present or only present in an attenuated manner in the base material 11. In this case, the coating 12 remains present, so that the shot peening does not or does not significantly remove the coating 12.

In the variant of FIG. 10, on the other hand, the coating 12 is specifically removed by the shot peening. In this case, the marking 3 preferably acts as a type of protective layer, so that the coating 12 remains below the marking 3. Deviating from the illustration in FIG. 10, it is not absolutely necessary for the impressions 7 to continue in the region of the marking 3 from the base material 11 to the marking 3.

The coating 12 is, for example, a scaling protection layer, for example, of an aluminum-silicon alloy. A thickness of the scaling protective layer is, for example, at least 100 nm or 250 nm or 1 μm and/or at most 30 μm or 10 μm or 2 μm. A preferred composition of the scaling layer is: 87% Al, 10% Si and 3% Fe. The preferred thickness of the scaling layer is 1.5 μm. These properties preferably also apply to coatings 12 in other exemplary embodiments.

The marking 3 is preferably thicker than the coating 12. This is preferably also true in all other exemplary embodiments.

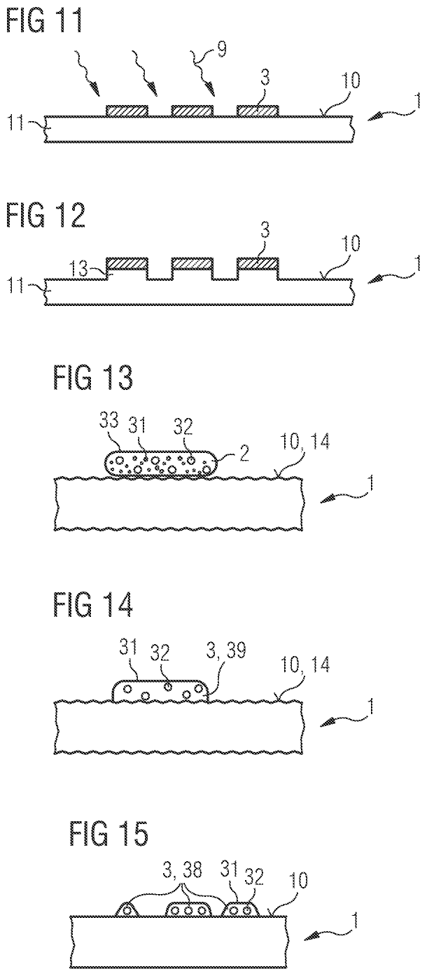

In the method of FIGS. 11 and 12, the finished marking 3 is exposed to an etching agent 9, see FIG. 11. The marking 3 is not influenced or not significantly influenced by the etching agent 9, so that the marking 3 overcomes the etching and remains without loss of function. However, by means of the etching means 9, material removal from the base material 11 takes place, see FIG. 12. Thus, under the regions for the marking 3, a plurality of bases 13 are produced from the base material 11. Unlike in FIG. 12, smaller undercuts can also extend below the regions with the marking 3, so that the bases 13 can be narrower than the regions with the marking 3.

Optionally, a coating on the base material 11 is also present in the method of FIGS. 11 and 12. The etching may then be limited to the coating or may concern both the coating and the base material 11.

The composition of the raw material 2 and of the marking 3 is described in more detail in FIGS. 13 to 15. The statements relating to FIGS. 13 to 15 apply equally to all other exemplary embodiments. In the steps of FIGS. 13 to 15, the workpiece surface 10 is formed directly by the base material or also by the coating.

According to FIG. 13, the raw material 2 is applied to the workpiece 1 as a paste or as an ink. In this case, the workpiece surface 10 preferably has a roughening 14, which results, for example, from a rolling of the workpiece 1. In particular on account of a surface tension, it is possible for the raw material 2 to rest on tips of the roughening 14, but not to contact the workpiece 1 over its entire surface.

The raw material 2 is preferably composed of an adhesion promoter 31, for example, a low-melting glass, of pigment particles 32, preferably phosphor particles or alternatively ceramic pigments, and of a binder and/or solvent 33.

The raw material 2 is preferably an ink-jet-capable ink, in particular having a viscosity in the range of from 1 mPas to 20 mPas and/or with a surface tension in the range from 20 mN/m to 60 mN/m, especially at the temperature at which the raw material 2 is printed.

The ink-jet-capable raw material 2 is preferably composed as follows:
1% by weight to 10% by weight, with respect to the total formulation of the raw material 2: solids,
75% by weight to 95% by weight, with respect to the total formulation: solvent,
0.1% by weight to 10% by weight, with respect to the solids in the raw material 2: binder,
0.1% by weight to 10% by weight, with respect to the solids in the raw material 2: dispersant,
1% by weight to 10% by weight, with respect to the total formulation: additives.

If the raw material 2 is a screen printing paste, the raw material 2 preferably has a viscosity between 1 dPas and 200 dPas at the application temperature and is composed, in particular, as follows:
40% by weight to 80% by weight: solids,
10% by weight to 35% by weight: solvent,
1% by weight to 10% by weight: binder,
1% by weight to 10% by weight: dispersant,
1% by weight to 5% by weight: plasticizer, and
1% by weight to 5% by weight: additives.

FIG. 14 shows the marking 3 resulting by a temperature treatment from the raw material 2. In this case, the adhesion promoter 31 forms a matrix material into which the pigment particles 32 are preferably embedded and uniformly distributed. A coherent marking field 39 is thus formed by the temperature treatment. The marking field 39 can be more even on a side facing away from the workpiece surface 10 than the workpiece surface 10. That is, by means of the marking 3, the workpiece 1 is smoother in places of the marking 3 than in other regions of the workpiece surface 10.

Unlike in FIG. 14, a plurality of islands 38, each comprising one or more of the pigment particles 32, are formed by the temperature treatment in FIG. 15. The islands 38 preferably also each comprise the adhesion promoter 31. As a result of this structure of the marking 3, the workpiece 1 is optionally rougher in the region of the marking 3 than in other regions of the workpiece surface 10.

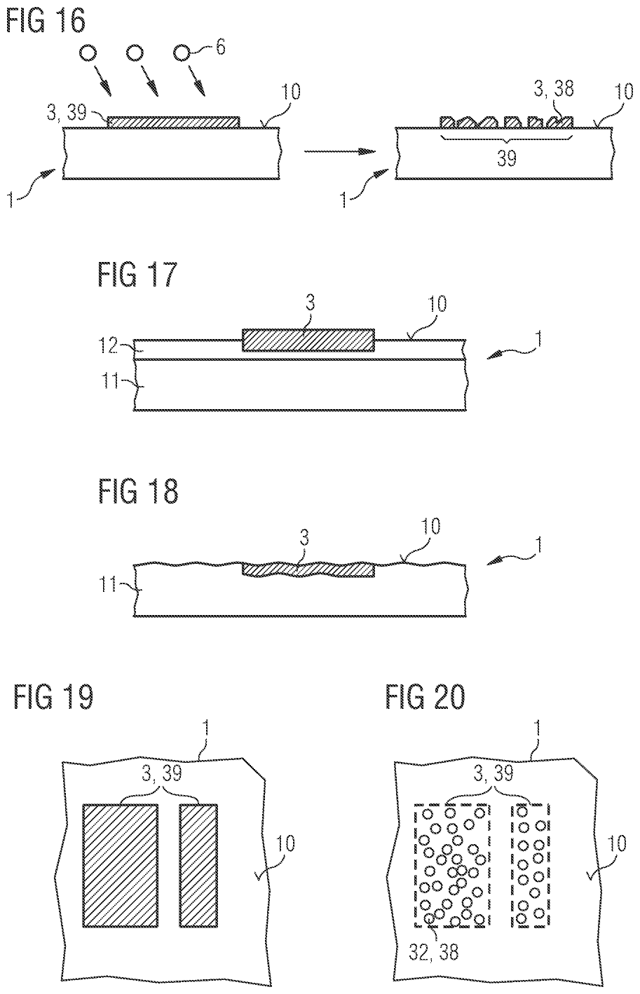

In the method step of FIG. 16, it is illustrated that the marking 3 is still a continuous, coherent marking field 39 at the beginning of the shot peening with the balls 6; see the left-hand side of FIG. 16. It is possible that the marking 3 is split into individual islands 38 by the shot peening; see the right-hand side of FIG. 16. However, the marking field 39 remains clearly identifiable as such.

To simplify the illustration, the impressions 7 in FIG. 16 are not shown. In addition, the coating on the base material can also be present in FIG. 16.

The fragmentation of the marking 3 during the shot peening illustrated in FIG. 16 optionally also occurs in the methods and workpieces 1 of FIGS. 1 to 10, 17 and 18. Alternatively, the markings 3 in FIGS. 1 to 10, 17 and 18 each remain as closed, gapless or predominantly gapless marking fields.

FIGS. 17 and 18 each show workpieces 1 after the surface treatment. According to FIG. 17, the marking 3, in particular by the shot peening, is partially pressed into the coating 12. Deviating from the illustration in FIG. 17, the marking 3 can also be pressed through the entire coating 12 and can touch the base material 11. In addition, it is possible that the coating 12 and the marking 3 terminate flush with one another.

In FIG. 18, the marking 3 is completely or substantially completely pressed into the workpiece surface 10. Thus, the marking 3, which is preferably split as shown in FIG. 16, on the right side, is flush or approximately flush with the base material 11 and is partially or completely pressed into the base material 11.

FIGS. 19 and 20 illustrate that the marking 3 is designed as a code in plan view, in particular as machine-readable code. By means of the marking 3, for example, a lettering, a bar code or a QR code is formed.

In this case, the marking 3 can be formed by the coherent marking fields 39 present as closed layers; see FIG. 19. Alternatively, the marking fields 39 are composed of a plurality of adjacent islands 38, see FIG. 20.

The invention described here is not limited by the description on the basis of the exemplary embodiments. Rather, the invention encompasses any novel feature and any combination of features, which in particular includes any combination of features in the claims, even if this feature or this combination itself is not explicitly specified in the claims or exemplary embodiments.

1.-14. (canceled)

15. A method comprising:
providing a workpiece;
attaching a marking to the workpiece such that the marking is integrally bonded to the workpiece, wherein attaching comprises applying at least one raw material for the marking;
heating the workpiece with the at least one raw material such that the marking is formed from the at least one raw material; and
performing a surface treatment of the workpiece at least in an area with the marking,
wherein performing the surface treatment comprises shot peening, sand blasting or material-removing etching against which the marking is resistant to,
wherein the marking remains readable on the workpiece at least until after performing the surface treatment,
wherein the marking has, in at least a part of a near ultraviolet, a visible and/or a near-infrared spectral range relative to the workpiece, at least one of a degree of reflection difference, a reflectance difference or an albedo difference of at least 10 percentage points,
wherein the workpiece is made of a metallic base material, and
wherein the method is performed in the order as recited.

16. The method according to claim 15,
wherein performing surface treatment comprises shot peening, and
wherein the workpiece is a metal sheet.

17. The method according to claim 15, wherein attaching the marking to the workpiece comprises applying the at least one raw material directly to the base material of the workpiece so that the marking is produced directly on the base material.

18. The method according to claim 15,
wherein the workpiece comprises a coating, and
wherein attaching the marking to the workpiece comprises applying the at least one raw material to the coating, which covers the base material of the workpiece at least in places such that the marking is produced directly on the coating and remains spaced apart from the base material.

19. The method according to claim 15,
wherein the workpiece contains iron, and
wherein a scaling layer is formed in regions next to the marking while heating the workpiece.

20. The method according to claim 19, wherein performing the surface treatment of the workpiece comprises removing the scaling layer.

21. The method according to claim 15, wherein heating the workpiece comprises:
hot forming the workpiece, and
forming the marking from the at least one raw material while hot forming the workpiece.

22. The method according to claim 15, wherein the at least one raw material comprises an inorganic adhesion promoter and inorganic pigment particles.

23. The method according to claim 22, wherein the adhesion promoter is a glass, a ceramic or a glass ceramic.

24. The method according to claim 22, wherein the pigment particles include at least one phosphor and/or at least one metal oxide.

25. The method according to claim 15,
wherein providing the surface treatment comprises material-removing sand blasting, and
wherein the marking is resistant to sand blasting so that the marking is retained at least until after providing the surface treatment.

26. The method according to claim 15, wherein the marking is raised above the workpiece after performing the surface treatment, and wherein performing the surface treatment is shot peening.

27. The method according to claim 26, wherein a hardness of the workpiece is increased by shot peening.

28. The method according to claim 15, wherein attaching the marking to the workpiece comprises pressing at least parts of the marking into the workpiece.

29. The method according to claim 15, wherein performing the surface treatment comprises pressing at least parts of the marking into the workpiece.

30. A workpiece comprising:
a marking in places on a workpiece surface of the workpiece,
wherein the marking is attached on the workpiece surface in a positive substance joining manner, and
wherein the workpiece surface has been subjected to a shot peening or a sliding grinding.

31. The workpiece according to claim 30, wherein the workpiece surface has been subjected to the shot peening so that the workpiece surface comprises a plurality of impressions of balls of the shot peening and the impressions extend across the marking.

32. The workpiece according to claim 30, wherein the workpiece is produced by the method according to claim 15.

33. A method comprising:
providing a workpiece;
attaching a marking to the workpiece such that the marking is integrally bonded to the workpiece, wherein attaching the marking comprises applying at least one raw material for the marking to the workpiece;
heating the workpiece with the at least one raw material such that the marking is formed from the at least one raw material; and
performing a surface treatment of the workpiece at least in an area with the marking, wherein performing the surface treatment comprises shot peening,
wherein the marking remains readable on the workpiece at least until after performing the surface treatment,
wherein the marking has, in at least a part of a near ultraviolet, a visible and/or a near-infrared spectral range relative to the workpiece, at least one of a degree of reflection difference, a reflectance difference or an albedo difference of at least 10 percentage points,
wherein the workpiece surface comprises a plurality of impressions of balls from shot peening and the impressions extend across the marking,
wherein the workpiece is made of a metallic base material, and
wherein the method is performed in the order as recited.
